(19) United States
(12) Patent Application Publication
(10) Pub. No.: US 2006/0237951 A1
(43) Pub. Date: Oct. 26, 2006

(54) Method for arranging an ejection channel at an airbag covering with integrated predetermined breaking line and a subassembly produced by this method

(75) Inventors: Norbert Preuss, Jena (DE); Michael Krug, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: JENOPTIK Automatisierungstechnik GmbH

(21) Appl. No.: 11/111,517

(22) Filed: Apr. 20, 2005

(51) Int. Cl. B60R 21/20

(52) U.S. Cl. 280/728.3

(57) ABSTRACT

In order to prevent mechanical loading of a predetermined breaking line integrated in an airbag covering when arranging an ejection channel by a material engagement, it is proposed, in accordance with the invention, that the material engagement be produced by laser transmission welding, wherein the contact pressing force required for this purpose is applied by a frictional engagement or positive engagement encompassing the joining surfaces to be welded.

### BACKGROUND OF THE INVENTION

a) Field of the Invention

The invention relates to an airbag covering with integrated airbag opening.

b) Description of the Related Art

In an airbag covering with integrated airbag opening, the size and shape of the opening produced for the passage of the airbag upon actuation of the latter is determined by the shape of a predetermined breaking line. By airbag covering is meant all of the vehicle's interior paneling or covering behind which an airbag is accommodated.

The predetermined breaking line often describes a closed rectangular, trapezoidal, oval, or freely shaped surface that is only interrupted by hinged areas and which releases an opening of the same shape and size when the predetermined breaking line is torn. The hinged area can also extend over an entire lateral length so that the predetermined breaking line assumes a U-shape, for example.

It is also known to form the predetermined breaking lines as connection lines of oppositely located points on the circumferential line of the intended opening contour. Examples are H-shaped or X-shaped predetermined breaking lines.

Regardless of the method by which the predetermined breaking line is introduced in the airbag covering, it generally constitutes a mechanical weakening of the airbag covering along this predetermined breaking line.

The degree of mechanical weakening must be selected in such a way that the airbag covering has a reproducible tearing resistance along this weakened line that is so slight that the predetermined breaking line tears dependably when the airbag is activated as a result of the defined pressing force acting thereon in order to release an opening for the passage of the airbag.

But the tearing resistance must also be sufficiently high that arbitrary mechanical forces acting from the driver's compartment side, e.g., due to passengers or cargo transported in the passenger compartment of the vehicle, do not lead even to a partial tearing of the predetermined breaking line.

Arbitrary forces and long-term stress due to natural environmental influences notwithstanding, the predetermined breaking point should not be permanently visible from the passenger compartment for aesthetic reasons.

When performing work on the airbag covering subsequently, e.g., to arrange an ejection channel, care must be taken to avoid damaging the predetermined breaking point.

The ejection channel is basically tubular and can have different cross-sectional shapes. It serves to limit the lateral expansion of the opening airbag and to guide the expansion direction of the airbag toward the passenger compartment. The ejection channel is substantially adapted, with respect to its inner circumference, to the shape of the opening. The outer shape of the ejection channel can be conceived differently. Often, various other functional parts such as air channels, fastening elements, cable holders, and the like are formed at the ejection channel outside of its actual functional area. In this case, the ejection channel can also be a component part of a more extensive understructure of the airbag covering.

Ideally, the inner circumference of the ejection channel adjoining the airbag covering would have to be somewhat smaller than the opening determined by the predetermined breaking line in order, on the one hand, to support the airbag covering along the predetermined breaking line and, on the other hand, to expand the airbag with maximum possible volume in the passenger compartment when activated.

In every case, the inner circumferential line of the ejection channel should be close to the predetermined breaking line. However, this is not readily allowed in the methods known from the prior art for mounting an ejection channel at the airbag covering.

The ejection channel and the airbag covering or, in case of a multiple-layer airbag covering, the inner layer facing the ejection channel are made of plastic.

Ultrasonic welding or friction welding are suitable for automated large-scale production and for producing a permanently secure connection between two plastic parts.

As is well known, the weld connection is brought about in ultrasonic welding by vibrations of the parts to be joined, i.e., dynamic mechanical forces act throughout the period of time over which the weld connection is produced and are also transmitted to the predetermined breaking line.

In friction welding, in addition to the dynamic mechanical forces acting during the entire process, static mechanical forces also act to press together the two parts to be joined.

In order to prevent mechanical forces as far as possible from loading the predetermined breaking line, the selected joint area cannot be in direct proximity to, or even adjoin, the predetermined breaking line.

Therefore, either the selected circumference of the ejection channel must be greater than the circumference of the intended airbag opening, or special steps must be taken in terms of construction.

The need for costly holding devices by which the airbag covering and the ejection channel are supported and held against one another during welding is also disadvantageous.

It is also known to the person skilled in the art to weld plastics by laser transmission welding. The person skilled in the art knows that a welding pressure must also be generated in this case during welding in order to produce the weld connection. Therefore, this method does not appear to be better suited as an alternative method.

### OBJECT AND SUMMARY OF THE INVENTION

It is the primary object of the invention to develop a method by which an ejection channel is connected to an airbag covering by welding without mechanical forces acting on the airbag covering.

It is also the object of the invention to provide a subassembly comprising an airbag covering and an ejection channel which can be connected to one another by a welding method without mechanical forces acting on the airbag covering during welding.

This object is met for a method according to the invention for arranging an ejection channel at an airbag covering with integrated predetermined breaking line comprising the following steps: producing a preliminary connection which positions and fixes an ejection channel relative to an airbag covering and in which the ejection channel and the airbag covering contact one another in a planar manner along joining surfaces within a ring-shaped joining area enclosing a predetermined breaking line by a frictional engagement or positive engagement of the preliminary connection and producing a material engagement between the joining surfaces of the preliminary connection by laser transmission welding, wherein the required welding pressure is imparted by the preliminary connection.

Further, in accordance with the invention, a subassembly comprises an airbag covering with an integrated predetermined breaking line and an ejection channel. A collar surrounding the predetermined breaking line is provided at the airbag covering. A ring shaped joining surface is formed at the collar and is connected by a frictional engagement or positive engagement and by a material engagement by laser transmission welding, to a joining surface formed at the ejection channel.

Advantageous constructions are indicated in the dependent claims.

It is essential to the invention that the mechanical contact pressing force between the two parts to be joined (ejection channel and airbag covering) that is required for welding is introduced and stored beforehand rather than during the welding process itself. This is accomplished in that the parts to be joined are fixed to one another by a frictional engagement or positive engagement. Joining can be carried out manually or automatically by a one-time application of static force outside the airbag opening, which does not load the predetermined breaking line.

The invention will be described more fully in the following by means of a drawing with reference to embodiment examples.

### BRIEF DESCRIPTION OF THE DRAWINGS

In the drawings:

FIG. 1 shows a subassembly with a press fit as preliminary connection;

FIG. 2 shows a subassembly with a conical connection as preliminary connection; and

FIG. 3 shows a subassembly with a snap-in connection as preliminary connection.

### DESCRIPTION OF THE PREFERRED EMBODIMENTS

In order to connect the airbag covering and the ejection channel to one another according to the invention, special constructional steps must be taken at the airbag covering and at the ejection channel, i.e., the geometry of the joining zone must be so adapted that a frictional engagement or positive engagement can be produced.

The airbag covering must have, on the side facing the ejection channel, an annular collar which surrounds the provided shape of the predetermined breaking line outside the airbag opening, and the ejection channel is placed on this annular collar in such a way that it extends in the area enclosed by the collar at most so as to just overlap the predetermined breaking line.

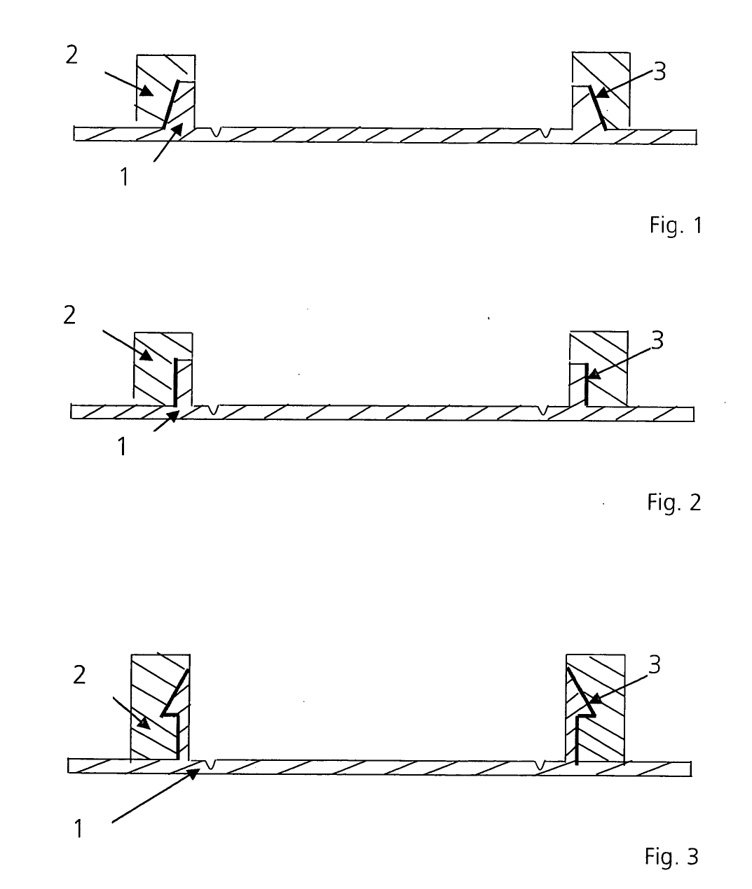

Examples of different possible cross-sectional shapes for the collar are shown in FIGS. 1 to 3. The ejection channel with connection to the collar is shown schematically in each case.

For example, FIG. 1 shows a trapezoidal or conical cross section of the collar formed at the airbag covering 1. By means of a corresponding shaping of the ejection channel 2, a conical mating which holds together the two parts to be joined by means of a frictional engagement is brought about when the two parts are joined. The force acts between the outer surfaces of the external cone formed at the collar and the internal cone formed at the ejection channel 2. These two outer surfaces also represent the joining surfaces 3 by which the two parts are to be welded together.

In FIG. 2, the collar cross section is rectangular. When mated with the ejection channel 2, another frictional engagement is brought about as a press fit. In this case also, the cylindrical surfaces that are pressed against one another are the joining surfaces 3 for the welding connection.

In FIG. 3, the two parts to be joined are connected by means of a snap-in connection.

Insofar as there is an absence of tension in the two parts in the preliminary joined state, that is, insofar as the connection relies purely upon a positive engagement, forces first act between the adjoining surfaces of the two parts only when the occurring material melt attempts to expand.

A direct screw connection, for example, would be a possible, but certainly less suitable, positive engagement.

Since the strength of laser weld connections is generally not inferior to the material strength, the spatial position of the joining surfaces at the airbag covering is not important in principle for reasons pertaining to strength. Ideally, the joining spaces are so disposed that they are acted upon only by shearing strain when the airbag expands. The geometry of the parts to be joined and the position of the joining surfaces will be so configured by the person skilled in the art that the laser beam needed for welding can be coupled in optimally.

In order not to interfere with the introduction of the predetermined breaking line, the height of the collar formed at the airbag covering is as low as possible and just sufficient to produce a preliminary joining connection, described above, with the ejection channel. The frictional engagement or positive engagement brought about in this manner is referred to hereinafter as the preliminary joining connection in order to clearly distinguish it from the actual connection produced by the laser transmission welding. The preliminary joining connection serves to position and fix the parts to be joined relative to one another and to store a contact pressing force by which the surfaces, hereinafter joining surfaces, are pressed against one another.

This contact pressing force subsequently causes the necessary welding pressure when producing a material engagement by means of laser transmission welding, which imparts permanent mechanical stability to the connection. When the preliminary joining connection is purely a positive engagement, this contact pressing force first occurs as a counterforce when the material melt forming in the joint area tries to expand.

The method of laser transmission welding and the need for a suitable combination of laser-transmitting and laser-absorbing materials are known to the person skilled in the art and need not be further described herein. Irradiation of the joining surfaces is possible, in principle, from the rear of the airbag covering to which the ejection channel is fastened as well as from the front insofar as only the material located in front of the joining surfaces in the irradiated area is transparent for the laser beam.

The preliminary joining of the parts to be joined has the decisive advantage that no costly apparatus is required during the laser transmission welding for holding the ejection channel and the airbag covering in the welding position under the influence of the required welding pressure.

The airbag covering can be held in the same holding device in which it is held when introducing the predetermined breaking line. During the welding process, no mechanical forces act on the airbag covering and, therefore, on the predetermined breaking point.

Persons knowledgeable in the field of the present invention will appreciate that the invention is not limited to the details of the embodiment forms provided by way of example in the description and that the present invention can be embodied in other special forms without departing from the scope of the invention as set forth in the appended claims.

What is claimed is:

1. A method for arranging an ejection channel at an airbag covering with integrated predetermined breaking line comprising the following steps:
producing a preliminary connection which positions and fixes an ejection channel relative to an airbag covering and in which the ejection channel and the airbag covering contact one another in a planar manner along joining surfaces within a ring-shaped joining area enclosing a predetermined breaking line by a frictional engagement or positive engagement of the preliminary connection; and
producing a material engagement between the joining surfaces of the preliminary connection by laser transmission welding, wherein the required welding pressure is imparted by the preliminary connection.

2. The method according to claim 1, wherein a frictional engagement is realized by means of a press fit.

3. The method according to claim 1, wherein a frictional engagement is realized by means of a conical connection.

4. The method according to claim 1, wherein a positive engagement is realized by means of a snap-in connection.

5. A subassembly comprising:
an airbag covering with an integrated predetermined breaking line and an ejection channel;
a collar surrounding said predetermined breaking line being provided at the airbag covering; and
a ring-shaped joining surface being formed at the collar and being connected, by a frictional engagement or positive engagement and by a material engagement by laser transmission welding, to a joining surface formed at the ejection channel.

6. The subassembly according to claim 5, wherein the joining surfaces are the outer surfaces of a cone.

7. The subassembly according to claim 5, wherein the joining surfaces are the outer surfaces of a cylinder.

8. The subassembly according to claim 5, wherein the joining surfaces are circular surfaces.
